(19) United States
(12) Patent Application Publication
(10) Pub. No.: US 2006/0174788 A1
(43) Pub. Date: Aug. 10, 2006

(54) Apparatus for applying a fluid to a printing forme

(75) Inventors: Josef Gottling, Friedberg (DE); Thomas Hartmann, Mering (DE); Alfons Schuster, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/351,375

(22) Filed: Feb. 9, 2006

(30) Foreign Application Priority Data
Feb. 10, 2005 (DE) 10 2005 006 064.1

(51) Int. Cl. B41F 31/00

(52) U.S. Cl. 101/350.2

(57) ABSTRACT

An apparatus for applying a conditioning solution, a rubber-covering solution, or a medium for producing an image-differentiating layer, to a surface to be coated, in particular to a rewritable and erasable printing forme positioned on a forme cylinder of a press, includes a coating roller which applies the fluid to the surface to be coated. The coating roller rolls on the surface to be coated and simultaneously executes a translational movement along an axis of rotation of the coating roller relative to the surface to be coated. A smoothing roller which evens out a layer thickness of the fluid on the coating roller rolls on the coating roller. The coating roller has a dry or fluid-free section at the front, in the direction of the translational movement, and a rear section, wherein a device applying the fluid to the coating roller applies to fluid only to the rear section.

### BACKGROUND OF THE INVENTION

The invention relates to an apparatus for applying a conditioning solution, a rubber-covering solution, or a medium for producing an image-differentiating layer, to a surface to a rewritable and erasable printing forme positioned on a forme cylinder of a press.

Methods for printing with printing formes include methods which operate with a printing forme that can be written once and methods which operate with a rewritable printing forme Printing methods which use rewritable printing formes are referred to using the keyword “computer to press/direct imaging”. Under the product designation “DICOweb”, the applicant markets digital presses which operate with rewritable and erasable printing formes. With regard to the principles of the “DiCOweb” technology, reference can be made to “Handbuch der Printmedien [Print Media Handbook], Helmut Kipphan, pages 674-680, 2000, Springer-Verlag”.

During the production of such rewritable and erasable “DICOweb” printing formes, a printing forme preferably positioned on a forme cylinder is subjected to an erasure step and an imaging step. Following imaging, fixing and conditioning of the printing forme are carried out, it being possible for the conditioning to the carried out before or after the fixing. The conditioning of the printing forme is used, inter alia, to reinforce printing and non-printing regions of the printing forme and to make the non-printing regions of the printing forme hydrophilic. Furthermore, in printing technology it is already usual to provide printing formes with rubber coverings on their surfaces in order to protect the same against contamination or damage by atmospheric oxygen.

During the rubber-covering of the printing forme, a rubber solution has to be applied to the printing forme; during conditioning, on the other hand, a Conditioning solution. During the imaging of a printing forme, an image-differentiating medium is applied to the printing forme in order to produce a layer that carries a printed image. The present invention relates to an apparatus for the gentle and uniform application of a fluid to a surface to be coated, in particular to a rewritable and erasable printing forme positioned on the forme cylinder of a press.

U.S. Pat. No. 5,170,706 discloses an apparatus for rubber covering a printing forme of a conventional press. According to the prior art of U.S. Pat. No. 5,170,706 the solution needed for the rubber-covering is applied to the printing forme with a damping solution applicator roll of a damping unit of the press. The disadvantage of applying the rubber-covering solution with the damping solution applicator roll is that, as a result, the lifetime and the properties of the damping solution applicator roll are affected detrimentally and there is a risk of soiling the damping solution as a result of the ingress of dirt particles. Furthermore, the residual ink normally found on the damping solution applicator roll is disadvantageous for the rubber-covering operation. The known application of the rubber-covering solution via the damping unit of the press is therefore disadvantageous overall.

### SUMMARY OF THE INVENTION

An object of the present invention is to provide a novel apparatus for applying a fluid, in particular a conditioning solution or a rubber-covering solution or a medium for producing an image-differentiating layer, to a surface to be coated, in particular to a rewritable and erasable printing forme positioned on the forme cylinder of a press.

The object of the present invention is met by an apparatus for applying a conditioning solution, a rubber-covering solution, or a medium for producing an image-differentiating layer, to a surface to be coated, the apparatus having a coating roller for applying the fluid to the surface to be coated, the coating roller rolling on the surface to be coated and simultaneously executing a translational movement along an axis of rotation of the coating roller relative to the surface to be coated. The apparatus further comprises a smoothing roller which evens out a layer thickness of the fluid on the coating roller, preferably rolling on the coating roller.

The object is also met by an apparatus for applying a fluid, in particular a conditioning solution or a rubber-covering solution or a medium for producing an image-differentiating layer, to a surface to be coated, the apparatus having a coating roller for applying the fluid to the surface to be coated, the coating roller rolling on the surface to be coated and simultaneously executing a translational movement along an axis of rotation of the coating roller relative to the surface to be coated. The coating roller also has a dry or fluid-free section at a front of the coating roller, as seen in the direction of the translational movement, and a device applying the fluid to the coating roller exclusively in a rear section of the coating roller following the dry or fluid-free section.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a partial sectional view of an apparatus according to the invention for applying a fluid to a surface to be coated according to a first embodiment of the present invention, together with a cylindrical surface to be coated;

FIG. 2 is a partial sectional view of the apparatus according to FIG. 1 together with a flat surface to be coated;

FIG. 3 is a front view of a coating roller along line III-III in FIG. 1;

FIG. 4 is a side view of the coating roller with a separate drive;

FIG. 5 is a side view of the coating roller with a drive according to a further embodiment; and

FIG. 6 is a schematic view of the coating roller and a forme cylinder.

### DETAILED DESCRIPTION OF THE PRESENTLY PREFERRED EMBODIMENTS

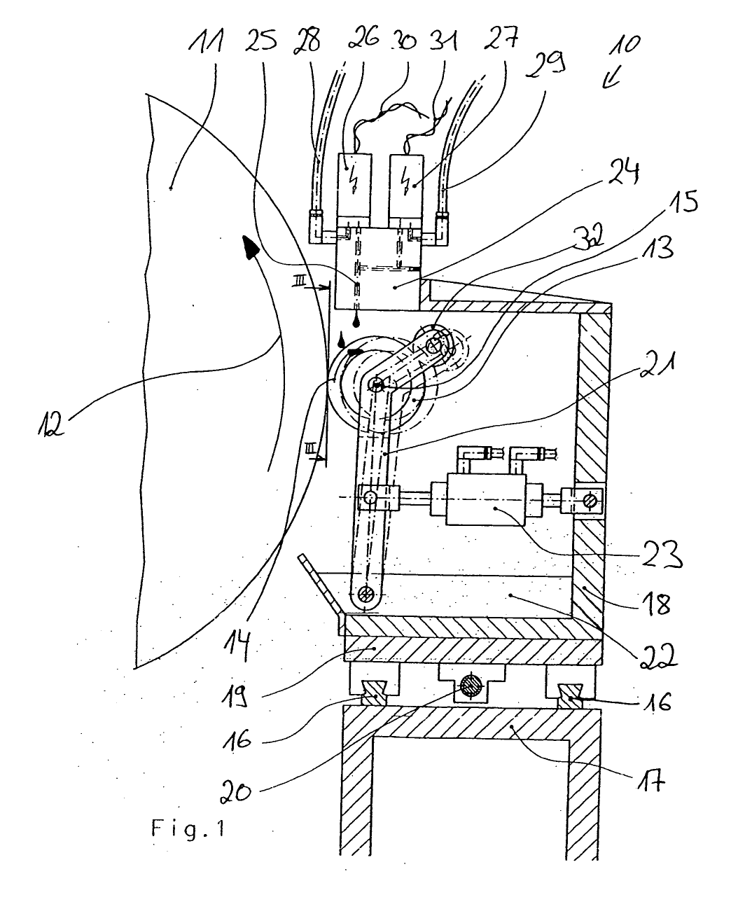

FIG. 1 shows an apparatus 10 according to an embodiment of the present invention for applying fluid to a surface to be coated belonging to a press. The apparatus 10 in FIG. 1 is used for the application of a conditioning medium car a rubber-covering medium to a rewritable and erasable printing forme positioned on a forme cylinder 11, as used in DICOweb presses. During the application of the fluid to the rewritable and erasable printing forme, the forme cylinder 11 is driven in rotation in the direction of the arrow 12.

A coating roller 13 is used to apply the fluid to the rewritable and erasable printing forme. The coating roller 13 applies the fluid to the surface to be coated or the printing forme in that, on the one hand, the coating roller 13 rolls on the surface to be coated in the direction of the arrow 14 and in that, on the other hand, as it rolls, the coating roller 13 is moved translationally or linearly in the direction of an axis of rotation 15 of the coating roller 13 relative to the surface to be coated.

In order to provide the linear or translational mobility of the apparatus 10 relative to the surface to be coated, the entire apparatus 10 is mounted on a carrier or crossmember 17 via linear guides 16 such that the apparatus 10 can be moved. For this purpose, a housing 18 or a frame of the apparatus 10 is fixed on a traversing unit 19 which can be moved along the crossmember 17 via a linear drive 20. The crossmember 17 preferably extends over the entire axial length of the forme cylinder 11 and therefore of the surface to be coated.

Inside the housing 18, the coating roller 13 is mounted on a pivoting lever 21. The pivoting lever 21 is mounted on a bottom trough 22 of the housing 18 by a lower section such that it can be rotated or pivoted. An adjusting device 23 acts on the pivoting lever 21, with the aid of which the pivoting lever 21 and therefore the coating roller 13 can be pivoted. The adjusting device 23 can be constructed as a pneumatic or an electric adjusting device. The adjusting device 23 is used to set the coating roller 13 onto and off of the surface to be coated. FIG. 1 shows in continuous lines the coating roller 13 in the position set onto the forme cylinder 11 and in dashed lines in a position set off the forme cylinder 11.

Positioned above the coating roller 13 is a device for applying a fluid to the coating roller 13. The fluid is applied with the aid of the coating roller 13 to the surface to be coated or to the printing forme positioned on the forme cylinder 11. In the exemplary embodiment of FIG. 1, this device has a nozzle block 24 having a bore or opening 25, to which a fluid can be supplied by a two controllable valves 26 and 27. The valve 26 is in contact with a feed line 28 for the fluid actually to be applied. The valve 27 is in contact with a feed line 29 for cleaning fluid. Valves 26 and 27 can be opened and closed in response to connecting lines 30 and 31.

If required, further valves may be used to apply a plurality of fluids simultaneously or in parallel, which will then be mixed for the first time on the surface to be coated.

To apply the fluid to the printing forme positioned on the forme cylinder 11, the procedure is accordingly such that, with the forme cylinder 11 rotating, the coating roller 13 is set onto the forme cylinder 11 so that the coating roller 13 rolls on the forme cylinder 11 in the direction of the arrow 14. At the same time, a translational or linear relative movement is established between the coating roller 13 and the forme cylinder 11, by moving the entire apparatus 10 linearly along the crossmember 17. The fluid reaches the coating roller 13 by the nozzle block 24, it being possible for the quantity of fluid to be set exactly by the valve 26. If the fluid to be applied to the printing forme tends to dry out, then water can be applied to the coating roller 13, for example via the feed line 29, to prevent the fluid from drying out on the coating roller 13 or, if necessary, to clean the opening 25. In the case of very small quantities of fluid to be applied, the valve 26 may be permanently opened, metering then being carried out via a suitable pump.

A smoothing roller 32 rolls on the coating roller 13. The smoothing roller 32 is mounted on the pivoting lever 21 together with the coating roller 13, so that the smoothing roller 32 can be pivoted with respect to the forme cylinder 11 together with the coating roller 13 without changing a relative position between the smoothing roller 32 and the coating roller 13. According to FIG. 1, the smoothing roller 32 has a smaller diameter than the coating roller 13 and rolls on the coating roller 13 with a predetermined force.

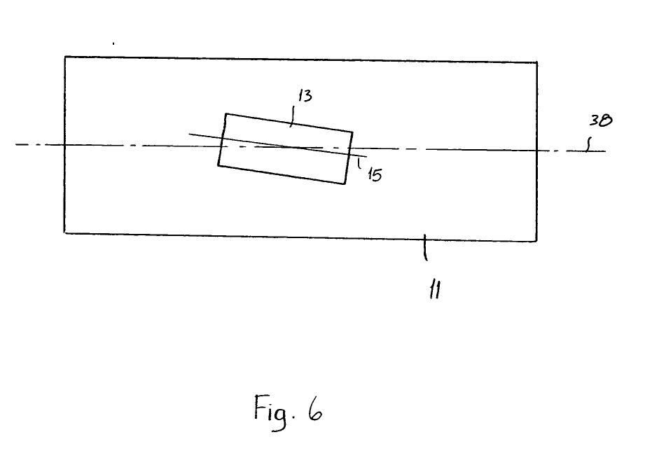

The coating roller 13 is preferably driven by friction with the surface to be coated or with the forme cylinder 11, as shown in FIG. 1. In this case, the smoothing roller 32 is also driven by friction with the coating roller 13. Alternatively, it is possible for the coating roller 13 to be assigned a separate drive 36 (see FIG. 4), it being possible for the surface speed of the coating roller 13 to be set synchronously, slower than synchronously or faster than synchronously with the surface speed of the forme cylinder 11. In this case, the smoothing roller 32 is either driven indirectly by friction with the coating roller 13 (FIG. 4) or directly by a connection 37 to the drive 36 assigned to the coating roller 13 (FIG. 5).

The smoothing roller 32 is used to even out or smooth the fluid on the coating roller 13. In the case in which the coating roller 13 is assigned a separate drive 36, the evenness and the thickness of the fluid layer to be applied can be influenced by adjusting the surface speed of the coating roller 13. As a result of the superimposed translational relative movement of the coating roller 13 relative to the forme cylinder 11, a fluidic helix is produced on the coating roller 13. Depending on the width of the coating roller 13, this can lead to the fluid being rolled over repeatedly before the fluid is applied by the coating roller 13 to the surface to be coated. This repeated rolling over can be used for the purpose of forming the most uniform and thin fluid film possible on the coating roller 13.

As shown in FIG. 3, the coating roller 13 preferably has, in the axial direction of the same, two sections 13a, 13b or regions separated from each other. A section 13b located in front as seen in the direction 35 of the translational relative movement of the coating roller 13 is formed as a dry or fluid-free section. In this way, a dry rolling zone of the coating roller 13 on the forme cylinder 11 is created, which is advantageous in particular when the coating roller 13 is driven by friction from the forme cylinder 11. As seen in the direction 35 of movement, after this dry rolling zone there follows a moist section 13a of the coating roller 13, onto which the fluid is applied to the coating roller 13 with the aid of the nozzle block 24. This fluid-carrying section 13a of the coating roller 13 is accordingly positioned after the dry or fluid-free section 13b, as seen in the translational direction 35 of movement.

The axis 15 of the coating roller 13 can be inclined with respect to an axis 38 of the rewritable and erasable printing forme to be coated positioned on the forme cylinder 11 as shown in FIG. 6.

With the apparatus 10 according to the present invention, fluidic media, which are used for example in the rewritable and erasable printing formes for printing image generation, can be applied reliably and uniformly. For example, with the apparatus 10 according to the present invention, a fluid can be applied to a printing forme, which fluid is subsequently dried and treated with a laser in an image-differentiating manner. For example, with the aid of the apparatus 10, a printing forme can be provided with an ink-carrying coating, the regions of the ink-carrying coating which are intended to print later being fixed on a hydrophilic printing forme with the aid of a laser, and it being possible for the regions not acted on by the laser to the removed subsequently from the printing forme, for example with the aid of a damping solution. Alternatively, it is also possible, with the aid of the apparatus 10, to apply a water-carrying coating to the printing forme to be coated, specifically in regions which are intended not to print later. These regions are then fixed on the printing forme with the aid of a laser; the remaining coating can in turn be removed from the surface of the printing forme, for example with the aid of a damping solution. Furthermore, it is possible, with the aid of the apparatus 10, to apply two-dimensionally to the printing forme a coating which is not ink-carrying and which is changed with the aid of a laser in such a way that, in some sections, ink-carrying points are produced and therefore dry offset printing is possible. It is also possible, with the aid of the apparatus 10, to apply two-dimensionally to the printing forme a coating of switchable polymers which is hydrophilic and which is changed with the aid of a laser in such a way that ink-carrying points are produced and, as a result, image differentiation is possible. A converse behaviour of the coating of switchable polymers is also possible, that is to say to apply a hydrophobic coating, which is then made hydrophilic. Furthermore, further coatings can be applied by the apparatus according to the present invention to a surface to be coated which can later be subjected to an image-differentiating step.

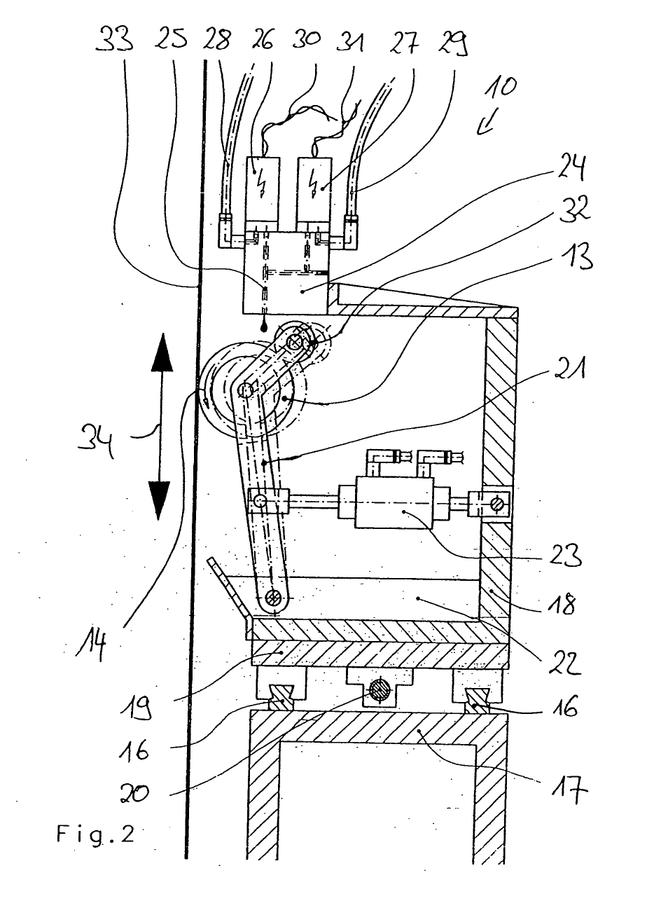

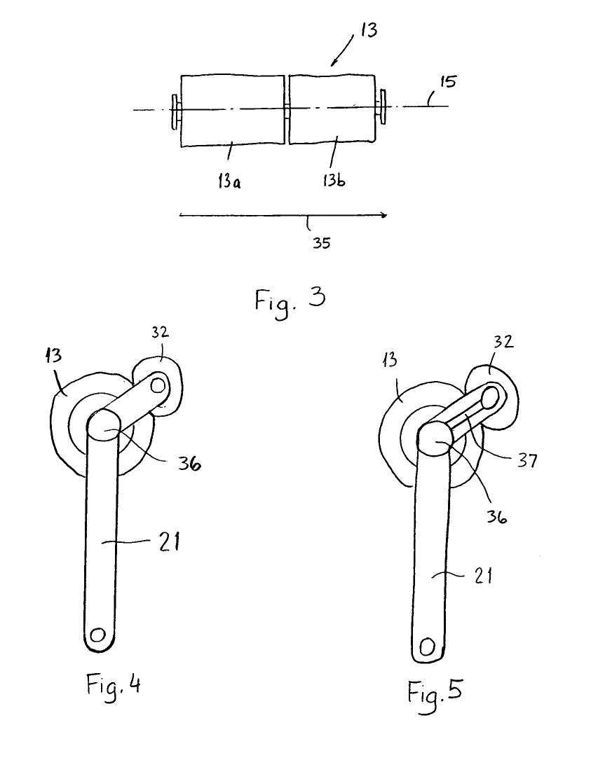

With reference to FIG. 1, the apparatus 10 according to the present invention has been described in conjunction with a cylindrical surface to be coated. According to FIG. 2, a flat plate 33 can be coated by using the apparatus 10 according to the present invention. This plate is then preferably moved to and fro in the direction of the double arrow 34 during the coating.

The application of fluid to the coating roller is preferably carried out, according to FIGS. 1 and 2, by the nozzle block 24. However, the fluid can also be applied to the coating roller in any other way. For example, the fluid can be kept ready in a dip bath, a cylinder which transfers the fluid to the coating roller projecting into the dip bath. The application of the fluid to the coating roller can also be carried out by a doctor device, preferably by a roll doctor.

Furthermore, the application of the fluid to the coating roller can be carried out by a thin layer generating device. In the thin layer generating device, the fluid is kept ready in a chamber and, induced by the relative movement between the coating roller and the chamber, the fluid is transferred to the coating roller without contact. For this purpose, a closely defined gap is maintained between the chamber and the coating roller, this narrow gap then performing a sealing function when the coating roller is stationary, so that no fluid can escape from the chamber of the thin layer generating device.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. An apparatus for applying fluid comprising one of a conditioning solution, a rubber-covering solution, or a medium for producing an image-differentiating layer, to a surface to be coated on a rewriteable and erasable printing forme, said apparatus comprising a coating roller for applying the fluid to the surface to be coated, wherein said coating roller is arranged and dimensioned so that said coating roller rolls on the surface to be coated and simultaneously executes a translational movement along an axis of rotation of the coating roller relative to the surface to be coated.

2. The apparatus of claim 1, further comprising a smoothing roller arranged relative to said coating roller so that said smoothing roller rolls on said coating roller and thereby evens out a layer thickness of the fluid on said coating roller.

3. The apparatus of claim 2, wherein said smoothing roller rolls on said coating roller with a predetermined force.

4. The apparatus of claim 2, wherein said smoothing roller has a smaller diameter than said coating roller.

5. The apparatus of claim 2, further comprising a pivoting lever, wherein said smoothing roller and said coating roller are jointly mounted on said pivoting lever such that said smoothing roller and said coating roller are pivotable jointly with respect to the surface to be coated and so that a relative position between said smoothing roller and said coating roller remains unchanged.

6. The apparatus of claim 2, wherein said coating roller is arranged and dimensioned so that said coating roller is driven by friction with the surface to be coated when said coating roller is pivoted to a position against the surface to be coated, and said smoothing roller is driven by friction with said coating roller.

7. The apparatus of claim 2, further comprising a separate drive for rotating said coating roller, and said smoothing roller being drivable one of indirectly by friction with said coating roller or directly by said drive of said coating roller.

8. The apparatus of claim 1, wherein the printing forme is arranged on a forme cylinder of a press, an axis of said coating roller being inclined with respect to an axis of the forme cylinder.

9. The apparatus of claim 1, further comprising a device applying fluid to the coating roller, wherein said coating roller comprises a dry or fluid-free section at a front end, relative to the direction of the translational movement, and a rear section following the dry or fluid-free section in said direction of the translational movement, wherein only said rear section receives fluid from said device.

10. An apparatus for applying fluid comprising one of a conditioning solution, a rubber-covering solution, or a medium for producing an image-differentiating layer, to a surface to be coated on a rewriteable and erasable printing forme, said apparatus comprising:
a coating roller for applying the fluid to the surface to be coated, wherein said coating roller is arranged and dimensioned so that said coating roller rolls on the surface to be coated and simultaneously executes a translational movement along an axis of rotation of the coating roller relative to the surface to be coated, wherein said coating roller comprises a dry or fluid-free section at a front end, as seen in the direction of the translational movement, and a rear section following the dry or fluid-free section in said direction of the translational movement; and
a device applying fluid to the coating roller, wherein only said rear section receives fluid from said device.

11. The apparatus of claim 10, further comprising a smoothing roller arranged relative to said coating roller so that said smoothing roller rolls on said coating roller and thereby evens out a layer thickness of the fluid on said coating roller.

12. The apparatus of claim 11, wherein said smoothing roller rolls on said coating roller with a predetermined force.

13. The apparatus of claim 11, wherein said smoothing roller has a smaller diameter than said coating roller.

14. The apparatus of claim 11, further comprising a pivoting lever, wherein said smoothing roller and said coating roller are jointly mounted on said pivoting lever such that said smoothing roller and said coating roller are pivotable jointly with respect to the surface to be coated and so that a relative position between said smoothing roller and said coating roller remains unchanged.

15. The apparatus of claim 11, wherein said coating roller is arranged and dimensioned so that said coating roller is driven by friction with the surface to be coated when said coating roller is pivoted to a position against the surface to be coated, and said smoothing roller is driven by friction with said coating roller.

16. The apparatus of claim 11, further comprising a separate drive for rotating said coating roller, and said smoothing roller being drivable one of indirectly by friction with said coating roller or directly by said drive of said coating roller.

17. The apparatus of claim 10, wherein the printing forme is arranged on a forme cylinder of a press, an axis of said coating roller being inclined with respect to an axis of a the forme cylinder.
